(19) United States
(12) Patent Application Publication
(10) Pub. No.: US 2024/0354727 A1
(43) Pub. Date: Oct. 24, 2024

(54) SYSTEM AND METHOD FOR OBTAINING PROVISIONAL CREDIT FOR MERCHANTS OF CRYPTOCURRENCY ATM MACHINES

(71) Applicant: Mark Thomas Ochab, Bernardsville, NY (US)

(72) Inventor: Mark Thomas Ochab, Bernardsville, NY (US)

(21) Appl. No.: 18/206,053

(22) Filed: Jun. 5, 2023

Related U.S. Application Data
(63) Continuation of application No. 17/161,236, filed on Jan. 28, 2021, now abandoned.
(60) Provisional application No. 63/090,526, filed on Oct. 12, 2020.

(51) Int. Cl. G06Q 20/10; G06F 16/11; G06Q 20/02; G06Q 20/18; G06Q 20/20; G06Q 20/40; G06Q 40/03; H04L 9/40

(52) U.S. Cl. CPC G06Q 20/1085; G06F 16/116; G06Q 20/023; G06Q 20/18; G06Q 20/202; G06Q 20/4037; G06Q 40/03; H04L 63/0428; G06Q 20/0655; G06Q 2220/00

(57) ABSTRACT

A system and method for obtaining provisional credit for operators of kiosks, such as cryptocurrency automated teller machines, comprises a kiosk application server disposed in connection with a financial institution, the kiosk application server configured to execute a transaction between the kiosk and a customer thereof, to record transaction data associated with such transaction, and to generate a file comprising same. Such generated file may comprise a first entry, disposed to post to the operator's account, and a second entry, disposed to post to the financial institution's general ledger account, wherein the posting of each entry will offset, thereby enabling the posting of provisional credit to the kiosk operator. Such a kiosk application server may further comprise a reconciliation component configured to remediate any imbalances between the posted provisional credit and the cash disposed within the kiosk via monitoring and verification procedures, and the transmission of a remedial file.

### CLAIM OF PRIORITY

The present application is a Continuation of the currently pending and earlier filed Non-Provisional patent application having the Ser. No. 17/161,236 and a filing date of Jan. 28, 2021, which itself claims priority to an earlier filed Provisional patent application having the Ser. No. 63/090,526 and a filing date of Oct. 12, 2020, the contents of each of which are hereby incorporated in its entirety.

### BACKGROUND OF THE INVENTION

### Field of the Invention

The present invention is directed to a system and method for obtaining provisional credit to operators of kiosks, such as cryptocurrency automated teller machines, via the posting of offsetting transactional entries to the core processor of a financial institution, and for the reconciliation of inaccuracies present in same.

### Description of the Related Art

The availability float regarding funds is a problem which has plagued many businesses over the years. Specifically, due to the delay between the time a financial institution, such as a bank, receives an account holder's deposit, whether through cash, check, or otherwise, and the subsequent recordation and posting of such deposit into the account holder's financial account, the funds associated with such deposit are effectively held in abeyance by the financial institution and are therefore inaccessible by the account holder. As may be understood, this delay between the receipt of the deposit and the subsequent recordation and posting thereof causes problems for many business as their ability to spend is essentially encumbered until they receive access to such funds. Such a problem is only exacerbated for businesses dealing in commodities which fluctuate in value on a daily, or even hourly basis, as inaccessibility to such funds may cause such businesses to miss out on lower priced commodities, thereby negatively affecting their profit margins.

Owners and operators of cryptocurrency automated teller machines (“BTMs”) are very familiar with such availability float problems. Specifically, operators of such BTMs commonly experience long delays between the initial transaction, the subsequent deposit, and the ultimate posting of the funds to their account, at least in part due to certain operational roadblocks which serve to exacerbate the availability float problem.

One such operational roadblock pertains to the common usage of cash at BTMs. While it is true certain kiosks, such as automated teller machines (“ATM”), are disposed to accept debit and credit cards as a form of payment, such is not the case with BTMs. Specifically, because BTMs offer services to unbanked customers, it may be understood BTMs typically deal solely in cash. Likewise, it may be understood many customers of BTMs prefer to use cash in such transactions because the possibility of charge backs on such debit/credit card may reduce the perceived profit margins of such an individual. Accordingly, as cash is the most common type of currency utilized at BTMs, operators are forced to utilize posting systems designed to function effectively with cash.

However, as may be understood, obtaining postings for cash deposits at BTMs is often inefficient, at least in part due to the inherent logistics of transporting cash to the pertinent financial institution. Indeed, cash handling traditionally involves several manual and costly processes including, without limitation, collecting, counting, and reconciling cash numerous times before the funds may be posted to the operator's account. Such a problem is exacerbated when an operator owns multiple BTMs in a given region or even simply where a single BTM executes a lot of transactions every day. Because such cash handling processes requires such extensive time and effort, it may be understood delays in credit postings may be quite severe, thereby emphasizing the need for greater efficiency in a system designed to obtain credit for BTM operators.

Such inefficiency commonly proves quite costly for owners of BTMs because such a business is inherently driven by volatile swings in the pricing for the tokens sold thereunder, which even further impacts the consequences for a delay in funds posting. More specifically, it is commonly understood cryptocurrencies, such as Bitcoin and Ethereum, commonly fluctuate in price by multiple percentage points within any given day. Moreover, such fluctuations May commonly last for several days prior to a volatile swing back in the opposite direction. As such, when BTM operators are required to replenish their tokens, they are commonly left at the whims of the market as such fluctuations affect the price they purchase at, thereby affecting the operator's profit margins. For this reason, BTM operators ideally want to replenish their virtual coin wallet at times where the relevant cryptocurrency is at a low value, thereby increasing their profit potential.

Yet, as previously stated, BTM operators often do not have access to the fruits of their transactions due to the aforementioned logistical problems inherent in their business. As such, BTM operators are commonly forced to replenish their virtual wallet at inopportune times, thereby negatively impacting their profit potential.

Accordingly, there is a need for a system designed to effectively and efficiently obtain BTM operators' provisional credit without the delay of such prior systems. Such a system should be designed to obtain BTM operators with provisional credit on the same day as the BTM's transaction with a customer occurred. Likewise, such a system should be designed to handle the logistical problems associated with the cash problems previously mentioned herein by, for instance, the provision of real-time monitoring of cash through the cash cycle and the provision of real-time reconciliation procedures for same. Further, such a system should be efficiently designed for operators who own a plurality of BTM machines, such that the operator thereof may obtain their provisional credit simply, and without the need to visit or otherwise interact with the plurality of BTM machines. Accordingly, any such system should be operatively disposed to streamline control of the cash cycle and allow for faster reconciliation thereof, while simultaneously providing BTM operators with greater ability to efficiently rotate their working capital.

### SUMMARY OF THE INVENTION

The present invention is directed to a system and method for obtaining provisional credit for the operators of kiosks, such as BTMs. As used herein, the term operator, merchant, and owner may be used interchangeably, as they generally refer to the individual and/or entity exercising control over the kiosk(s). Likewise, as may be understood, the term kiosk, while nominally used in reference to BTMs herein, may also refer to other types of booths, counters, ATMs, machines, or systems for which the operators thereof may need to obtain provisional credit in an efficient and effective manner.

In at least one embodiment of the present invention, the system thereof may generally comprise a kiosk application server disposed in connection with the core processor of at least one financial institution. Such a financial institution may comprise, for instance, an originating deposit financial institution, or any other like institution designed to effectuate the banking procedures recited herein. Such a core processor may comprise, for instance, at least the account of the operator of the kiosk, such as a demand deposit account, and the financial institution's account with the Federal Reserve, such as its general ledger account.

As may be understood, the kiosk application server may be disposed on each kiosk, and, in embodiments wherein the operator thereof owns at least two, and in some instances a plurality of kiosks, it may be understood each kiosk may have a kiosk application server operatively connected with the remaining kiosk application servers disposed on the remaining kiosks. In this manner, it may be understood the kiosk application server may represent a plurality of same disposed on a plurality of kiosks, wherein the kiosk application server serves to operatively connect a plurality of kiosks with at least one financial institution.

In terms of the operative connection between the kiosk and the financial institution, it May be understood the connection there between may be constructed through a variety of means, such as a peer-to-peer network or a client/server network, provided such means enable the functionality described herein. Further, it may be understood the operative connection between the kiosk and the financial institution may likewise include an intervening connection, wherein at least some transactional data may first be sent to such intervening connection prior to submittal of same to the financial institution. Such an intervening connection may comprise, for instance, a third-party application programming interface disposed to record and/or display the transactional data and/or the reconciliation data, or any other like system disposed to effectuate certain processes. For example, such a third-party application programming interface may be disposed to record the transactional data and assist in cash collections and auditing procedures.

Moving forward, a kiosk application server in accordance with at least one embodiment of the present invention may comprise a transaction component, a file generation component, and a transmission component. As may be understood, such components may be operatively disposed in connection with each other, for the creation of a file and the subsequent transmission thereof to the pertinent financial institution.

The transaction component may be configured so as to effectuate a transaction between the cryptocurrency held within the kiosk and the user of such a kiosk. For instance, a transaction component to be used in connection with the present invention may comprise a hot wallet or other like digital wallet disposed to hold tokens from any given cryptocurrency for the ultimate transmission to a user of the kiosk. Such a hot wallet may be disposed to hold the actual tokens or, conversely, such a hot wallet may instead be disposed in connection with some liquidity on a cryptocurrency exchange platform, wherein a transaction for the purchase of such cryptocurrency will be automatically completed upon the user's interaction with the kiosk. As may be understood, such a transaction component may be disposed to automatically record certain information relating to the user's completed transaction. Such information may comprise, for instance, the user's personal information, such as his or her name, the date of the transaction, and the financial information pertaining to such transaction, such as the amount deposited into the kiosk and the amount of tokens exchanged therefor.

Further, in at least one embodiment of the present invention, the kiosk application server may comprise a file generation component. Such a file generation component may be operatively constructed to generate a file for the data recorded by the transaction component. As may be understood, such a file generation component may create any file type now known or hereafter discovered. For instance, such a file generation component in accordance with one embodiment of the present invention may generate a file using an interchange file format, such as IF3 or IF4. Alternatively, such a file generation component may generate a file using the X9.37 file format, or any other like file format commonly used in an electronic check exchange. Likewise, in an alternative embodiment such a file generation component may instead generate a file disposed to be in compliance with automated clearinghouse regulations, nominally referred to herein as a NACHA format. In such an alternative embodiment, it may be understood certain data, such as the data pertaining to the pertinent financial institution, may further be included in such a generated file as a result of the operative connection between the kiosk application server and the core processor of the pertinent financial institution.

Such a file generation component may further be disposed to create a given file type containing at least two, and in some instances a plurality of, transactions. For instance, such a file generation component may, at the close of a given day, create a single file containing each transaction executed at the given kiosk for that day. Likewise, in embodiments wherein a plurality of kiosks are interconnected, such a file may instead contain each transaction executed at each kiosk within the given day and/or relevant time period. As may be understood, such a file generation component may be disposed to alternatively create files at different time periods, whether daily, weekly, biweekly, etc.

Moreover, such a file generation component may be disposed to create at least two transactional entries within a file for any given executed transaction at a kiosk. In other words, for each transaction executed at a given kiosk, such a file generation component may generate two transactional entries, a first entry and a second entry, wherein the first entry and the second entry are disposed to offset one another. More specifically, the first entry and the second entry may be generated so as to post to different accounts for the same value, namely, the value of the executed transaction at the kiosk. Accordingly, the first entry may, upon its ultimate transmittal to the core processor of the financial institution, post to the account the operator holds at the financial institution, such as a demand deposit account. Conversely, the second entry, upon its ultimate transmittal to the core processor of the financial institution, may instead post to the account such financial institution holds with the Federal Reserve, such as the general ledger account. As may be understood, for files comprising a plurality of transactions, a pair of offsetting entries, such as the aforementioned first entry and second entry, may be individually created therefor, wherein such plurality of offsetting entry pairs may post to the pertinent accounts at the same time.

In this manner, it may be understood the first entry and the second entry, by posting offsetting values to the relevant accounts, may effectively counterbalance one another in the financial institution's accounts. In so doing, it may be understood the offsetting nature of the first entry and the second entry may ensure the operator may receive a provisional credit to their account without affecting the ledger of the financial institution's account with the Federal Reserve.

Further, the kiosk application server of at least one embodiment of the present invention may also comprise a transmission component. Such a transmission component may be operatively disposed to transmit the file generated by the file generation component to the core processor of the financial institution. While such a transmission component may operate through a plurality of means, one such means may comprise the use of a cryptographic network protocol disposed to secure network services and transmissions over unsecured networks. For instance, such a transmission component may be operatively disposed to utilize a secure shell protocol for authentication, connection, and encrypted file transfers to the financial institution, thereby enhancing the security of the transmission of the generated file.

However, as may be understood, in certain embodiments of the present invention, it is possible the file generated by the file generation component may not be ready to be transmitted directly to the core processor of the financial institution upon the generation thereof. For instance, in embodiments wherein the file generation component generates a file using a conventional format, such as an interchange file format, such a file may first need to be reformatted into a different file type prior to its ultimate transmittal to the core processor of the financial institution. More specifically, because at least one goal of the present invention may be to efficiently provide provisional credit to the operators of kiosks, and because the provision thereof may be expedited by providing the core processor of the financial institution with a file type which need not be first recognized and subsequently reformatted by such core processor, it may be understood the object of the present invention may be more conveniently served through the provision of a file type instantly recognized by the core processor of the financial institution. Such a file type May comprise, for instance, a NACHA file or any other file type used by financial institutions, whether now known or hereafter developed. In this sense, such a file type may be understood as a “posting file,” wherein such a posting file effectively comprises a file type which may be easily processed by the core processor of a financial institution, whether constituting a NACHA file or otherwise.

In accordance with the foregoing, it may be understood the present invention may further comprise a file reformatting component operatively disposed to reformat the generated file into a posting file. As previously stated, such a reformatted file may comprise, for instance, a NACHA file or any other like file designed to follow automated clearing house regulations. Such a posting file may likewise comprise both the first entry and the second entry for at least one transaction, and in some embodiments for all transactions executed at the kiosk(s), as disposed within the generated file. Such a file reformatting component may, in certain embodiments, be disposed within the kiosk application server. Alternatively, certain embodiments may instead transmit the generated file to an intervening connection, such as a third party application programming interface, disposed to reformat the generated file into the posting file, prior to subsequent transmittal of the reformatted file to the core processor of the financial institution.

Accordingly, at least one embodiment of the present invention may be understood as a method comprising a plurality of steps disposed to obtain provisional credit for an operator of a kiosk. Such a method may comprise the steps of: (1) executing a transaction with a customer of the kiosk; (2) recording data pertinent to the transaction; (3) generating a file with the recorded data; (4) transmitting the file to a financial institution; and (5) having provisional credit posted to the operator's account. Moreover, such a method may further comprise steps disposed to account for cash logistics and auditing procedures, wherein such steps comprise: (6) acquiring the cash deposits at predetermined intervals; (7) transporting the cash to a location for auditing procedures; and (8) transporting the cash to the pertinent financial institution, wherein the financial institution may adjust the funds disposed within the operator's account in accordance with the results garnered from the auditing procedures. In this manner, it may be understood an operator of a kiosk may obtain provisional credit prior to the occurrence of the cash logistics and auditing procedures.

More specifically, an embodiment of the present invention practicing such a method May first execute a transaction with a customer of the kiosk. The execution of such a transaction may occur through the kiosk application server. As may be understood, such an embodiment may also execute at least two, and in some cases a plurality of, transactions with a plurality of customers. Likewise, a plurality of transactions may be executed across a plurality of kiosks.

Next, the kiosk application server, or any other server operatively disposed to perform this step, may then record certain data relevant to each individual transaction. Such transaction data may comprise, for instance, the personal information of the customer executing the transaction, the financial information relevant to such transaction including, without limitation, the amount of provisional credit garnered from such transaction, and the date thereof. Moreover, in embodiments wherein a plurality of kiosks are executing transactions, such data may further comprise identifying information as to the particular kiosk executing such a transaction, such as a unique kiosk identifier. All such data may optionally, in certain embodiments, be displayed via a dashboard connected to a graphic user interface of a device, whether a computer, smartphone, or other like device, whether provided by the kiosk application server, an interconnected third-party application programming interface, or otherwise. Accordingly, it may be understood the operator of the kiosk(s) may thus be able to track all such transactions occurring at each kiosk location the operator owns.

Upon recordation of the aforementioned data, a file may then be generated. As previously stated, such a file may comprise a standard file type, such as an interchange file format, or may conversely comprise a file disposed in accordance with ACH formatting guidelines, such as a NACHA file. Such a generated file may further comprise a pair of offsetting entries for each transaction recorded in the prior step. Such a pair of offsetting entries may comprise a first entry, configured to post to the operator's account at the financial institution, and a second entry, configured to post to the financial institution's account with the Federal Reserve.

Following from the generation of such a file, it may be understood the file May subsequently be transmitted to the financial institution. Such a transmission may occur through secure means such as, for instance, a cryptographic network protocol such as secure shell. As May be understood, upon the transmittal of such a file, the file may then be ingested by the core processor of the financial institution and, due to the presence of the first entry and the second entry, provisional credit may then be posted to the operator's account without affecting the financial institution's account with the Federal Reserve.

As previously stated, such a method may further comprise steps for cash logistics and auditing procedures. For instance, after provisional credit is posted to the operator's account, the cash deposited within the kiosk, which was previously used to execute the transactions upon which the provisional credit is based, may subsequently be retrieved at predetermined intervals. The cash may be retrieved by, for instance, an armored car service or other like transportation means disposed to safely transport the cash from one location to another. As may be understood, such a predetermined interval may differ amongst operators and/or financial institutions. For instance, operators involved with greater numbers of transactions and/or a greater number of kiosks May require such predetermined intervals to occur more frequently. Likewise, certain financial institutions may require such predetermined intervals to occur more frequently according to their particular banking procedures. As may be understood, and in conjunction therewith, such a method may further allow for the provision of alarms, alerts, push notifications, or other like indicators to a user of the system to indicate the retrieval and safe transport of the cash, whether the user comprises the operator of the kiosk(s), the financial institution, or any other interested party.

Upon the retrieval of the cash deposited within the kiosk, the cash may then be transported to an appropriate auditing location. Such a location may comprise any location appropriate for such cash auditing procedures, such as a third party location or the financial institution itself. Once audited, the cash may be transported to the Federal Reserve. Alternatively, if desired, the cash May instead be transported to the financial institution for the ultimate balancing of accounts, wherein the provisional credit issued to the operator may then be adjusted according to the resulting of the auditing procedures.

For instance, at least one embodiment of the present invention may further comprise a kiosk application server having a reconciliation component disposed therein. Such a reconciliation component may be structured to coordinate the aforementioned cash logistics and auditing procedures, and monitor the effectuation of same. Specifically, such a reconciliation component may comprise: (1) a monitoring component, configured to monitor and track the pick-up of cash from the kiosk(s), and track the cash-in-transit; (2) a verification component, configured to verify the auditing of the cash-in-transit, thereby effectuating a comparison of the already issued amount of provisional credit and the cash vault deposits of the transported cash for the purpose of verifying the amounts at issue are accurate; and (3) a rectification component configured to remediate any imbalances determined by the verification component via the generation of a remedial file and the transmittal of same to the pertinent financial institution. Each of these components will be discussed in greater detail hereafter.

As previously stated, the reconciliation components in accordance with at least one embodiment of the present invention may optionally comprise a monitoring component disposed to monitor and track certain trigger events, such as cash pick-ups, cash-in-transit, and the deposit thereof in a cash vault. Such a monitoring component may be further configured to monitor for alternative types of data, such as accounting and/or auditing data. As may be understood, such a monitoring component may, in certain embodiments, be disposed on, or otherwise disposed in connection with, the kiosk application server, and may transmit all pertinent data to a database for viewing by the operator or any other interested and/or interconnected third-party. For instance, such a monitoring component may, in at least one embodiment, be interlinked with a third-party application programming interface, such that all pertinent data is displayed on a dashboard, or some other graphic user interface disposed to allow a user thereof to view and interact with such data.

As may be understood, the monitoring component in connection with at least one embodiment of the present invention may be specifically disposed to monitor certain trigger events in the cash cycle, such as the initial cash pick-up by a third-party transport, and the ultimate delivery and deposit of the cash in the cash vault. Likewise, as previously stated, the monitoring component may monitor the cycle of the cash in between such endpoints, such as by monitoring the cash-in-transit process. As such, it may be understood the monitoring component of at least one embodiment of the present invention may be configured so as to monitor for certain trigger events at certain predetermined monitoring intervals. For instance, a given kiosk may be monitored daily for the initial cash pick-up. Then, the cash may be monitored whilst in-transit on a similar daily basis, until same is deposited within the cash vault. Conversely, such a predetermined monitoring interval may instead comprise alternative intervals, whether weekly, bi-weekly, monthly, or any other interval deemed appropriate by the system, the operator, the Financial Institution, or otherwise. For instance, in at least one embodiment, the monitoring component May monitor a given kiosk on a monthly basis for alternative data, such as accounting and auditing data pertinent to a given kiosk, or the plurality of kiosks used by the operator.

In connection with the monitoring component of at least one embodiment of the present invention may be verification component configured to provide auditing procedures between the bank's general ledger and the cash vault deposits of the transported cash. Accordingly, it may be understood the verification component effectively verifies the amount of provisional credit issued to the operator of the BTM, determining whether such provisional credit constitutes an amount unequal to the amount originally disposed within the posting file transmitted to the Financial Institution.

Accordingly, in at least one embodiment of the present invention, the verification component may be configured in connection with the cash vault in which the transported cash is deposited. More specifically, the verification component may be configured such that any cash counting and/or auditing procedures employed on the transported cash, and the results which stem therefrom, may be transmitted to the verification component. As such, because the verification component may be configured within the kiosk application server, or otherwise disposed in connection therewith, the verification component may then employ a comparison analysis between the sum of transactional entries disposed within a given issuance of provisional credit to the operator. As such, the verification component may yield a remediation decision, thereby indicating whether the amount of provisional credit issued to the operator was correct or incorrect.

Upon such verification, a remediation decision may be encountered. In instances wherein the amount of provisional credit issued to the operator was correct, and therefore the remediation decision is negative, it may be understood the verification component may log such confirmation and the entire process may once again start over. In instances where remediation is required, however, the verification component may, in at least certain embodiments, have further steps to take. Specifically, such verification component may then categorize the type of remediation required, and the specific amount for same. For instance, the verification component May categorize a given kiosk and/or set of kiosks for a particular merchant as requiring a reconciliation for over issuance of provisional credit for a specified amount. Conversely, in instances where the amount of provisional credit was less than the amount of cash transferred, the verification component may instead categorize a given kiosk and/or set of kiosks for a particular merchant as requiring a reconciliation for an under-issuance of provisional credit for a specified amount. As may be understood, the foregoing are simply examples of possible categorizations, as any number of categorizations and/or remediation decisions may be possible dependent upon the facts garnered by the verification component.

As previously discussed, at least one embodiment of a reconciliation component of the present invention may comprise a rectification component. Such a rectification component may be disposed on, or in connection with, the kiosk application server. Moreover, such reconciliation component may be interconnected with certain components of the kiosk application server, such as the file generation component, the transmission component, and the file reformatting component. Accordingly, and as previously stated, the rectification component may be configured to take the results of the verification component, as categorized in at least one embodiment of the present invention, and direct such component to create, possibly reformat, and ultimately transmit a remedial file to the financial institution. As may be understood, such remedial file may be configured to remediate any discrepancies discerned by the verification component.

In accordance with the foregoing discussion pertaining to the file generation component, the transmission component, and the file reformatting component, it may be understood the remedial file may be configured and formatted in accordance therewith. Specifically, such remedial file may comprise two remedial offsetting transactional entries, wherein the first remedial entry posts to the operator's account with the financial institution and the second remedial entry posts to the financial institution's account with the Federal Reserve, in accordance with those procedures previously detailed herein. Likewise, in certain embodiments, the remedial file may be reformatted by the file reformatting component so it may be configured as a remedial posting file, whether comprising a NACHA file format or otherwise. As may be understood, upon the transmission of such remedial file to the financial institution, any discrepancies may be resolved and the operator may thus have an accurate amount of provisional credit posted to his or her account, whereas the financial institution's general ledger with the Federal Reserve may be finally balanced.

These and other objects, features, and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a block diagram depicting a system connecting a kiosk application server and a core processor of a financial institution in accordance with at least one embodiment of the present invention.

FIG. 2 is a block diagram depicting the interconnection between a plurality of kiosk in accordance with at least one embodiment of the present invention.

FIG. 3 is a block diagram depicting a system connecting a kiosk application server and a core processor of a financial institution in accordance with at least one embodiment of the present invention.

FIG. 4 is a block diagram depicting a kiosk application server in accordance with at least one embodiment of the present invention.

FIG. 5 is a block diagram depicting a system connecting a kiosk application server and a core processor of a financial institution, with an intervening connection disposed therebetween, in accordance with at least one embodiment of the present invention.

FIG. 6 is a block diagram depicting a method for obtaining provisional credit for kiosk operators, in accordance with at least one embodiment of the present invention.

FIG. 7 is a block diagram depicting a method for obtaining provisional credit for kiosk operators, in accordance with at least one embodiment of the present invention.

FIG. 8 is a block diagram depicting a system having a reconciliation component disposed in connection with the kiosk application server, in accordance with at least one embodiment of the present invention.

FIG. 9 is a block diagram depicting a kiosk application server in accordance with at least one embodiment of the present invention.

FIG. 10 is a block diagram depicting the components of a reconciliation component disposed in connection with a core processor of a financial institution, with an intervening connection disposed therebetween, in accordance with at least one embodiment of the present invention.

FIG. 11 is a block diagram depicting a reconciliation component in accordance with at least one embodiment of the present invention.

Like reference numerals refer to like parts throughout the several views of the drawings.

### DETAILED DESCRIPTION OF THE PREFERRED EMBODIMENT

The present invention is directed to a system and method for obtaining provisional credit for the operators of kiosks, including, without limitation, BTMs. More specifically, the present invention is directed towards obtaining such provisional credit on the same day a transaction between the kiosk and a customer thereof takes place, or at a predetermined interval determined by the operator and/or the pertinent financial institution, thereby providing the operator of such kiosk with available funds that were the subject of such transaction.

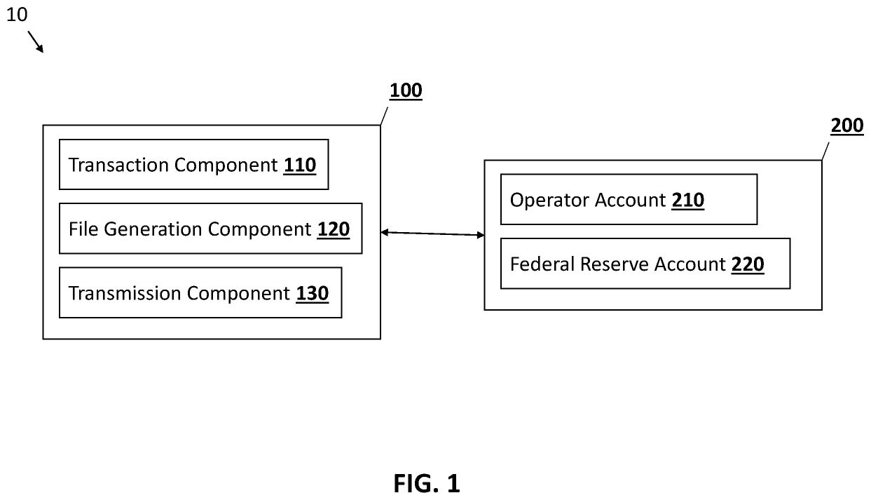

Depicted in FIG. 1 is at least one embodiment of the present invention wherein the system of the present invention comprises a kiosk application server 100 operatively connected to the core processor 200 of at least one financial institution. As may be understood, such operative connection between the kiosk application server 100 and the core processor 200 may be through a peer-to-peer network or other like network now known or hereafter discovered.

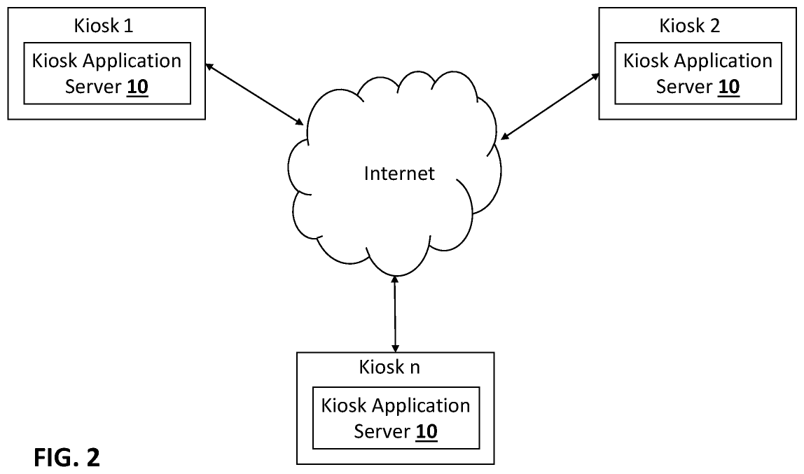

As previously mentioned, and as depicted in FIG. 2, the kiosk application server 100 of the present invention may be disposed on at least one, and in some instances, a plurality of kiosks owned by a single operator thereof. All such kiosks, such as kiosk 1, kiosk 2, and up to kiosk n, may be operatively connected to each other through the kiosk application server 100 disposed thereon. Accordingly, any transaction which takes place at a single kiosk 1 may be tracked through the remaining kiosks, kiosk 2 through kiosk n, for the aggregation thereof. In so doing, an operator's entire network of kiosks may be disposed in operative connection therewith.

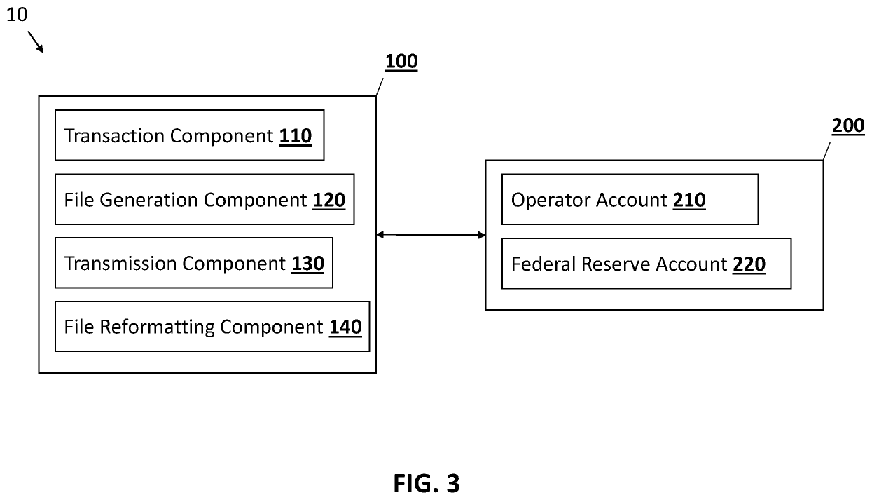

Returning to FIG. 1, it may be seen the kiosk server 100 of at least one embodiment of the present invention may comprise a transaction component 110, a file generation component 120, and a transmission component 130. With further reference to FIG. 3, which depicts at least one alternative embodiment of the present invention, it may be seen the kiosk server 100 may further comprise a file reformatting component 140.

The transaction component 110 of at least one embodiment of the present invention May be operatively disposed to execute a transaction between the operator of the kiosk and a user thereof. Accordingly, such a transaction component 110 may be disposed to effectuate a transfer of the commodities of the kiosk with the monies of the user. As used herein, the term commodities may refer to, for example, cryptocurrency tokens in the event the kiosk comprises a BTM, but May alternatively refer to other goods and/or currencies, such as those disposed within standard kiosks, vending machines, automated teller machines, etc.

In embodiments wherein the kiosk comprises a BTM, it may be understood the transaction component 110 may effectuate a transfer of at least one cryptocurrency token, or at least a portion thereof, in exchange for an amount of money to be deposited therein by the customer of the BTMs. As previously stated, the at least one cryptocurrency token which is the subject of a such a transaction may already be stored within a virtual wallet disposed in connection with the kiosk application server 100, wherein the transaction component 110 merely goes through the steps of detailing the transfer of same in an electronic ledger, such as a blockchain. Alternatively, such a cryptocurrency token(s) may instead be purchased off an exchange at the time of the execution of the transaction, wherein the transaction component 110 is disposed to effectuate the purchase of same. In this manner, it may be understood the transaction component 110 may be disposed to fully provide for the exchange and/or purchase of the cryptocurrency token(s) to and/or for the user of the kiosk. Moreover, it may be understood the transaction component 110 may further be configured to transfer the pertinent cryptocurrency tokens to a virtual wallet of the customer of the BTM.

Further, such a transaction component 110 may further be disposed to preliminarily record certain transaction data 111 associated with the pertinent transaction. As previously stated, such transaction data 111 may comprise, for instance, the user's personal information, the amount of money exchanged for the amount of cryptocurrency token(s), the date, and possibly a unique identifier associated with the given kiosk at which the transaction occurred. In this manner, each transaction executed at each kiosk owned by an operator thereof may be individually tracked and recorded. As will be discussed in greater detail hereafter, such transaction data 111 may further be displayed to the operator through a dashboard or other like interface.

The file generation component 120 of at least one embodiment of the present invention may be operatively disposed to generate a file comprising the aforementioned transaction data 111. The generated file 121 provided by the file generation component 120 may comprise a plurality of different file types. For instance, the format of the generated file 121 may comprise an interchange file format, such as IF3 or IF4. Alternatively, such a file generation component may generate a file using the X9.37 file format, or any other like file format commonly used in an electronic check exchange. Likewise, the generated file may instead be disposed to conform with the standards proffered by the automated clearing house regulations, and therefore may comprise, for example, a NACHA file, or any other like file constructed to conform to such regulations. As may be understood, and as previously stated, such a file generation component 120 may further be operatively disposed to aggregate all transactions occurring at an individual kiosk and/or at a plurality of kiosks owned by a single operator within a given timeframe. Such a timeframe May optionally comprise a single day, a week, or any other time period within which the operator of such kiosks seeks to obtain provisional credit.

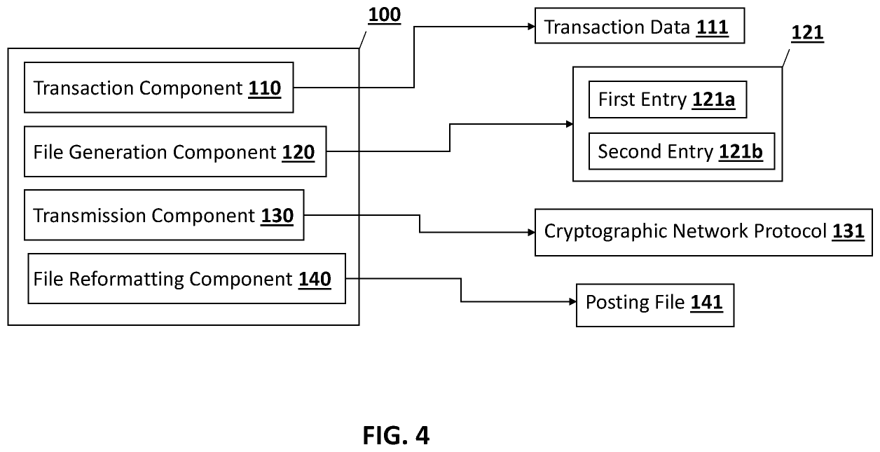

Further, the file generation component 120 of at least one embodiment of the present invention may be operatively disposed to create two offsetting entries therein for each individual transaction executed at a given kiosk. For instance, as shown in the embodiment depicted in FIG. 4, the file generation component 120 may construct a generated file 121 with a first entry 121a and a second entry 121b, wherein the first entry 121a and the second entry 121b are disposed to offset one another. Specifically, such a generated file 121 comprising a first entry 121a and a second entry 121b may be disposed to offset upon the subsequent transmission to the pertinent financial institution because the first entry 121a may be disposed to post an amount to the account the operator holds at the financial institution, such as a demand deposit account, whereas the second entry 121b may be disposed to post an equal amount to the account such financial institution holds with the Federal Reserve, such as their general ledger account.

Accordingly, it may be understood the generated file 121, by virtue of the first entry 121a and the second entry 121b, may be constructed so as to enable the financial institution to post provisional credit to the operator's account without affecting the financial institution's balance with the Federal Reserve. In this sense, such a generated file 121 comprising a first entry 121a and a second entry 121b may effectively comprise a credit from the operator, to the operator. More specifically, the first entry 121a may comprise a credit to the operator's account 210 with the financial institution, which may comprise, for instance, a demand deposit account. The second entry 121b, on the other hand, may comprise a debit of an equal amount to the aforementioned credit comprising the first entry 121a, to be posted to the financial institution's account with the Federal Reserve 220, which may comprise its general ledger account.

Upon the creation of the generated file 121, the kiosk application server 100 of at least one embodiment of the present may then transit the generated file 121 to the core processor of the financial institution 200 via a transmission component 130. Such a transmission component 130 may operate through a plurality of means. For instance, one such means may comprise the use of a cryptographic network protocol disposed to secure network services and transmissions over unsecured networks, such as a secure shell protocol for authentication, connection, and encrypted file transfers to the financial institution and/or any other interconnected systems, whether comprising alternative kiosks, intervening connection(s) 300, alternative third parties, or otherwise. Alternatively, certain embodiments of the present invention may instead provide for the transmission of the generated file 121 directly from the manufacturer of the equipment, without the use of the kiosk application server 100 or any cryptographic network protocol(s).

However, as previously stated, prior to such transmission, at least some embodiment of the present invention may first seek to ensure the generated file 121 is disposed within a format which may be easily processed by the core processor of the financial institution 200. Such a format May comprise, for instance, a NACHA file, or any other like file structured to conform with automated clearing house regulations, which may nominally be referred to herein as a posting file 141.

Specifically, in at least one embodiment of the present invention, such as the one depicted in FIGS. 3 and 4, the kiosk application server 100 may further comprise a file reformatting component 140 configured to reformat the generated file 121 to a posting file 141, wherein such a posting file 141 comprises a format which may be easily processed by the core processor of the financial institution 200. For instance, in an embodiment wherein the generated file 121 comprises an interchange file format, the file reformatting component 140 may be configured to reformat the generated file 121 to a posting file 141 comprising a NACHA file format. As may be understood, upon such reformatting, the posting file 141 may then be sent to the core processor of the financial institution 200. Because the posting file 141 will then comprise a file type instantly recognizable by such core processor of the financial institution 200, it may be understood the need thereof to perform recognition and reformatting tasks will be effectively eliminated, thereby effectuating a quicker posting of provisional credit to the operator's account. Moreover, it may be understood such a posting file 141 may be disposed to retain the first entry 121a and the second entry 121b of the generated file 121. As such, the pertinent amounts pertaining to the transaction recorded through the first entry 121a and the second entry 121b may be efficiently posted both the account the operator holds at the financial institution, such as a demand deposit account and the account such financial institution holds with the Federal Reserve, such as their general ledger account.

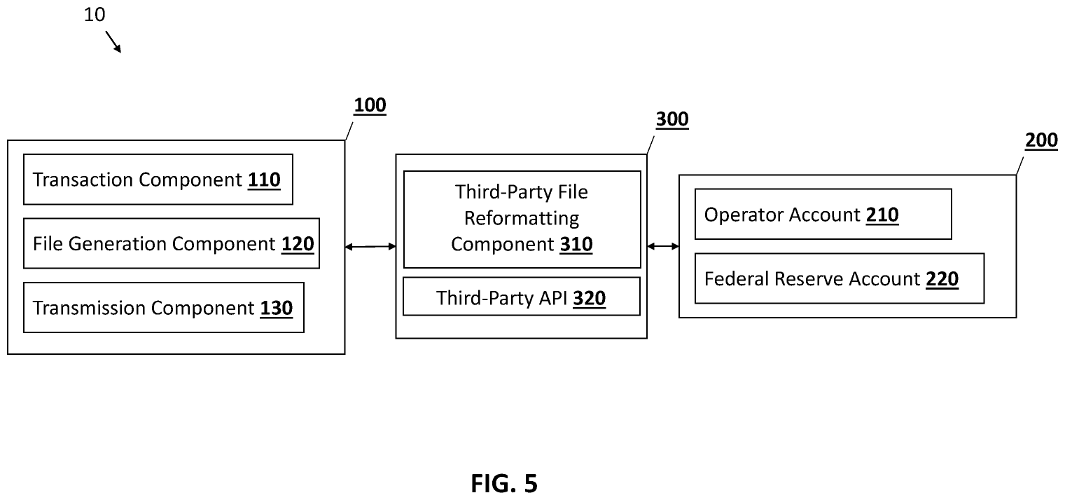

Further, as depicted in FIG. 5, it may be understood such file reformatting component 140 may be disposed within the server of an intervening connection 300 as opposed to being disposed within the kiosk application server 100. As may be understood, such an intervening connection 300 may comprise, for instance, a third-party application programming interface disposed to record the transaction data 111 into a posting file 141, or otherwise reformat the generated file 121 into a posting file 141. In this sense, it may be understood the intervening connection 300 may comprise a third-party file reformatting component 310 configured to format the pertinent transaction data 111 into a posting file 141 and/or reformat the generated file 121 into a posting file 141. As may be understood, once the intervening connection 300 has generated a posting file 141, such posting file 141 may then be transmitted to the core processor of the financial institution 200 for the subsequent posting of the transaction data 111 inherent therein to both the operator's account 210 with the financial institution and the financial institution's account with the federal reserve 220.

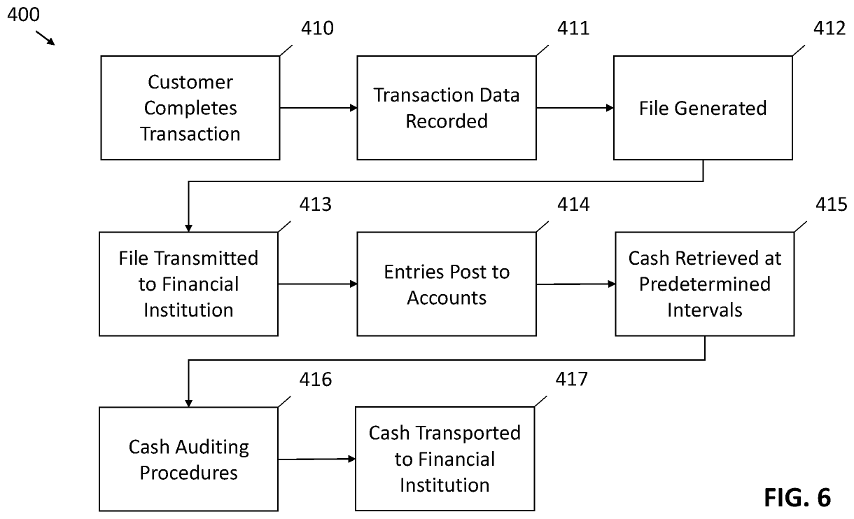

As may be understood, at least one embodiment of the present invention may be expressed as a method comprising a plurality of steps configured to obtain provisional credit for an operator of a kiosk, whether comprising a BTM or otherwise. For instance, and with reference to FIG. 6, at least one embodiment of such a method may initially comprise the completion of a transaction with a customer 110. As previously stated, the execution of a transaction may occur through the kiosk application server 100, as shown in FIGS. 1 and 3-5. Further, it may be understood such step may further comprise the completion of a plurality of transactions at a single kiosk and/or across a plurality of interconnected kiosks.

Upon the completion of a transaction with a customer of the kiosk 210, it may be understood a method in accordance with at least one embodiment of the present invention May then record the pertinent transaction data 211 associated with such transaction. Such transaction data 111 may comprise, for instance, the personal information of the customer executing the transaction, the financial information relevant to such transaction including, without limitation, the amount of provisional credit garnered from such transaction, and the date the transaction was completed. Moreover, in embodiments wherein the present method may be applied to a plurality of kiosks, such transaction data 111 may further comprise a unique kiosk identifier serving to identify which kiosk completed such transaction.

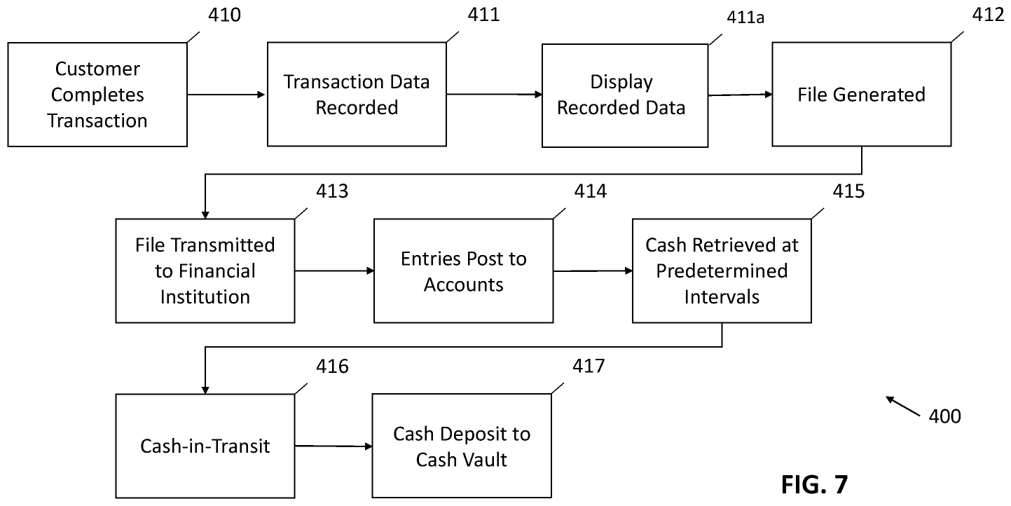

Optionally, in at least one alternative embodiment of the present invention, as may be seen in FIG. 7, such recorded transaction data 211 may then be displayed to the operator 411a. For instance, the display of such transaction data 411a may occur through a dashboard or other like platform connected to a graphic user interface of a device, whether a computer, smartphone, or otherwise, and whether proffered by the kiosk application server 100, an interconnected application programming interface 320, as depicted in FIGS. 5, 8, and 10, or otherwise. In conjunction therewith, it may be understood such a dashboard or other like platform may be operatively disposed to provide such information to a user in connection with alarms, alerts, push notifications, or any other like component designed to notify a user of the presence of such transaction data, whether such user comprises the operator, the financial institution, or any other interested party. Accordingly, in so doing, the method of at least one embodiment of the present invention may provide such an operator with the ability to track the execution of transactions across all owned and operated kiosks, and the transaction data 111 associated therewith. In this manner, it may be understood the operator may be provided with sufficient information to determine an expected provisional credit to be posted to their account at a set interval, whether daily, weekly, biweekly, or otherwise. Moreover, as may be understood, such a dashboard may, in certain embodiments, be interconnected with the operator's hot wallet or other like electronic account for the purposes of indicating to the operator how many cryptocurrency tokens are currently available, thereby further informing the operator as to whether he or she needs to replenish same.

Upon the recordation of the transaction data 411, the method in accordance with at least one embodiment of the present invention may then generate a file 412 comprising such transaction data 411. Such a file may be generated via, for instance, the file generation component 120 of the kiosk application server 100. As previously stated, such a file may comprise a standard file type, such as an interchange file format, or may conversely comprise a NACHA file or any other file type used by financial institutions or otherwise complying with automated clearing house regulations. As may be understood, the present step for the generation of a file 412 may further comprise reformatting processes disposed to reformat a standard file type, such as an interchange file format, into a posting file 141, whether comprising a NACHA file or other like file. Such reformatting may occur through a file reformatting component 140 disposed within the kiosk application server 100, or a third-party file reformatting component 310 disposed within an intervening connection 300. Moreover, it may be understood the generation of a file 412 may further comprise steps configured to provide a first entry 121a and a second entry 121b for each transaction therein.

Following the generation of a file 412, at least one embodiment of the present invention may then transmit such file to a financial institution 413. Such a transmission may occur through secure means such as, for instance, a cryptographic network protocol 131 utilized by a transmission component 130 of a kiosk application server 100. As may be understood, upon the transmittal of such a file, the file may then be ingested by the core processor of the financial institution 200 and, due to the presence of the first entry 121a and the second entry 121b of the generated file 121, provisional credit may then be posted 414 to the operator's account without affecting the balance of the general ledger of the financial institution.

As previously stated, at least one embodiment of the present invention may further provide solutions pertaining to cash logistics and auditing procedures. For instance, after provisional credit is posted to the operator's account, or alternatively in conjunction therewith, the cash deposited within the kiosk, which was previously used to execute the transactions upon which the provisional credit is based, may subsequently be retrieved at predetermined intervals 415. Such predetermined intervals may comprise any time applicable to the individual operator and/or the pertinent financial institution, wherein such predetermined interval may comprise a time period such as every day, weekly, biweekly, or any other applicable time interval. The cash disposed within the kiosks May be retrieved by any means, such as an armored car service or any other like vehicular system, whether proffered through a third-party or otherwise.

Upon the retrieval of the cash deposited within the kiosk 415, the cash may then be transported to an appropriate auditing location for the performance of cash auditing procedures 416. Such a location may comprise any location appropriate for such cash auditing procedures 417, such as a cash vault, whether operated by a third-party location of the pertinent financial institution itself. Once audited, the amount of provisional credit provided to the operator may then be rectified according to the results of such auditing procedures.

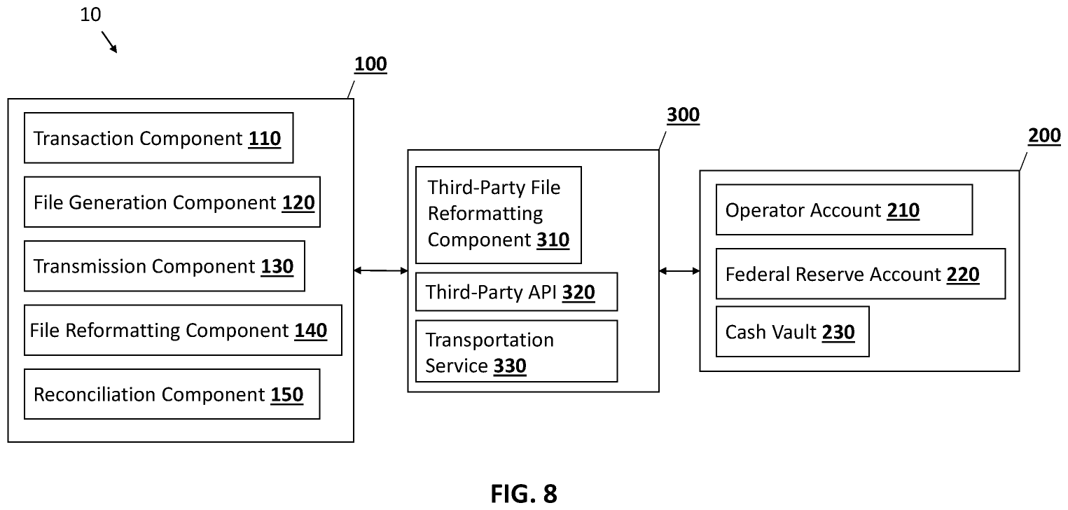

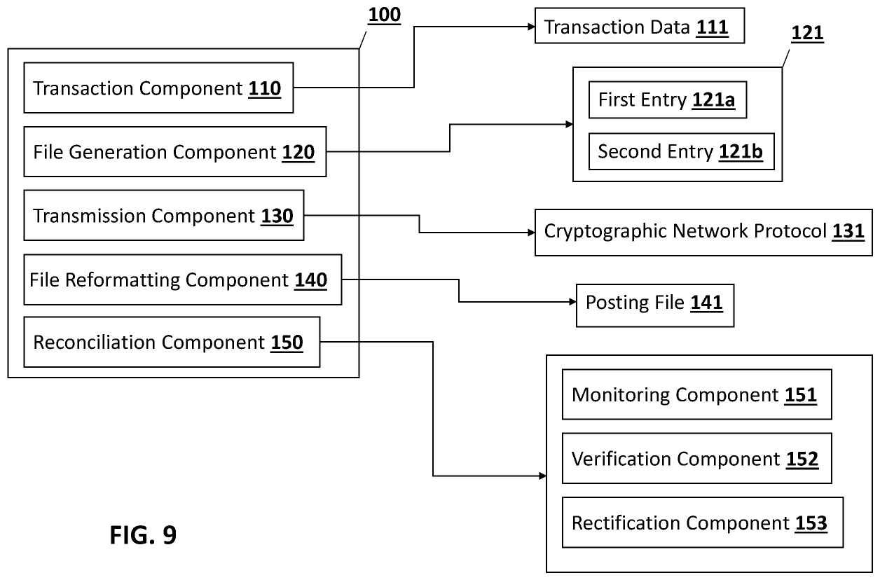

More specifically, and with reference to FIGS. 8-11, such cash auditing and logistics procedures in accordance with at least one embodiment of the present invention may be employed via a reconciliation component 150 disposed in connection with the kiosk application server 100, whether such reconciliation component 150 is disposed thereon or otherwise. Such reconciliation component 150 may be configured to coordinate the aforementioned cash auditing and logistics procedures, and further effectuate the monitoring thereof. As depicted in FIG. 9, a reconciliation component 150 in accordance with at least one embodiment of the present invention May comprise: (1) a monitoring component 151 configured to monitor and track the cash pick-ups from the kiosk(s) managed by the operator, and to further monitor the cash-in-transit from such pick-up to the deposit thereof into a cash vault; (2) a verification component 152 configured to verify the auditing of the cash transported to the cash vault, thereby verifying the amount of provisional credit previously afforded to the operator was accurate; and (3) a rectification component 153 configured to remediate any imbalances determined by the verification component.

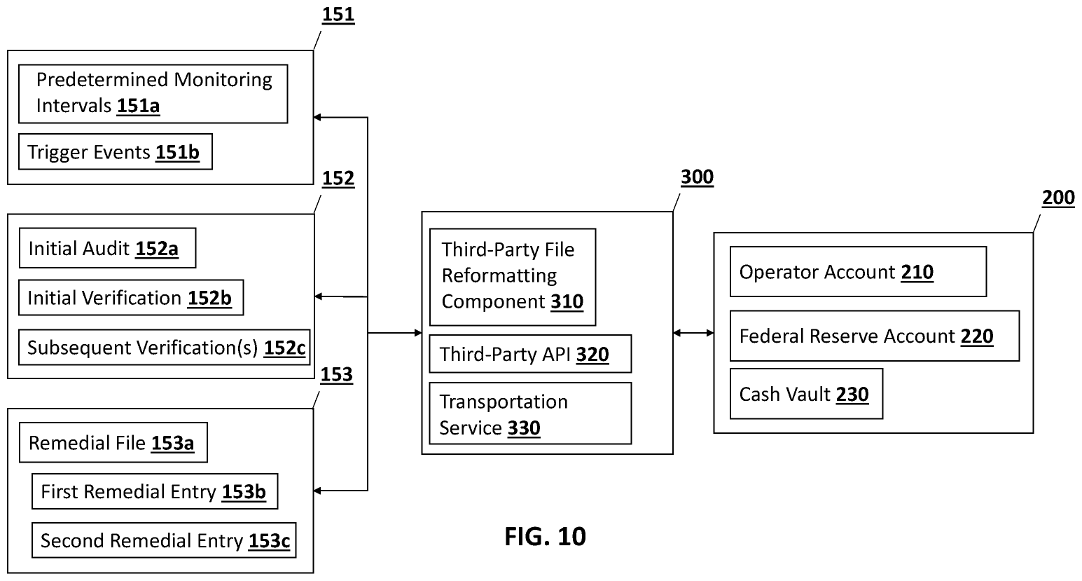

With further reference to FIG. 9, and additional reference to FIG. 10, the monitoring component 151 in accordance with at least one embodiment of the present invention may be configured to monitor and track cash pick-up, through cash-in-transit, and until the deposit thereof into a cash vault. Such cash pick-up, cash-in-transit, and cash deposit may be effectuated by a transportation service 330 which may comprise, for instance, an authorized third-party, such as the aforementioned armored car service or other like vehicular system, or by the operator and/or the financial institution themselves. The cash vault 230 may comprise, for instance, any location in which the cash may be stored, as may be determined by, for instance, the pertinent financial institution. For example, such a cash vault 230 may comprise a structure operated directly by the pertinent financial institution, whether at the location of such financial institution or otherwise, or, alternatively, may be operated by a third-party authorized by such financial institution.

As may be understood, because such a monitoring component 151 may be disposed on, or otherwise disposed in connection with, the kiosk application server 100, the monitoring component 151 may thus transmit all pertinent data to a database for viewing by the operator or any other interested and/or interconnected third-party 300, such as, for instance, the pertinent financial institution and/or the pertinent third-party transportation service 330. For instance, such a monitoring component 151 may, in at least one embodiment, be interlinked with a third-party application programming interface 320, such that all pertinent data is displayed on a dashboard, control panel, or some other graphical user interface operated by such application programming interface, thereby allowing the user thereof to view and interact with such data. As such, in at least one embodiment of the present invention, the party providing the system and method disposed herein may be configured to access such monitoring component 151, and any other data interconnected therewith, such as any data received and maintained by the kiosk application server 100, to assist in the monitoring of the cash-in-transit.

As may be understood, the monitoring component 151 in connection with at least one embodiment of the present invention may be specifically configured to monitor certain trigger events 151b in the cash cycle. Such trigger events 151b may comprise, for instance, the initial cash pick-up by the transportation service 415, the subsequent pick-ups at any other kiosk(s) managed by the operator or general cash-in-transit events 416, and the ultimate delivery thereof to the cash vault 417. As such, it may be understood the monitoring component 151 of at least one embodiment of the present invention may be configured so as to monitor for certain trigger events 151b at certain predetermined monitoring intervals 151a.

For instance, alternative embodiments of the present invention may be structured to monitor certain kiosk(s) on a daily basis for the occurrence of an inciting incident, namely, the initial cash pick-up 415. Upon such initial cash pick-up 415, the monitoring component 151 may then continue to monitor the transportation service 330 on a daily basis, or alternatively any other predetermined monitoring interval 151a, such as an hourly basis, until the ultimate deposit of the cash into the cash vault 417. Conversely, certain embodiments may instead monitor various kiosks and the transportation of the cash deposited therein, at various alternative predetermined monitoring intervals 151a suitable to either the operator, the pertinent financial institution, or both. For instance, such alternative predetermined monitoring intervals 151a may instead comprise, without limitation, weekly, bi-weekly, or monthly monitoring. Even further, the monitoring component 151 of at least one embodiment of the present invention may monitor any given kiosk at variable predetermined monitoring intervals 151a dependent upon the data to be monitored. Alternatively put, the monitoring component 151 may monitor the kiosk(s) for cash pick-up 415 on a daily basis, while likewise monitoring the kiosk(s) on a monthly basis for other types of data, such as, for instance, data pertaining to accounting and auditing information.

In at least one embodiment of the present invention, disposed in connected with such monitoring component 151 may be a verification component 152. For instance, with continued reference to FIGS. 7-11, the verification component 152 of at least one embodiment of the present invention may be configured to provide auditing procedures between the bank's general ledger and the cash vault deposits 417 of the transported cash. Accordingly, it may be understood the verification component 152 may thus verify the amount of provisional credit issued to the operator of the kiosk, thereby determining whether such provisional credit constitutes an amount equal to the amount originally disposed within the posting file 141 transmitted to the pertinent Financial Institution.

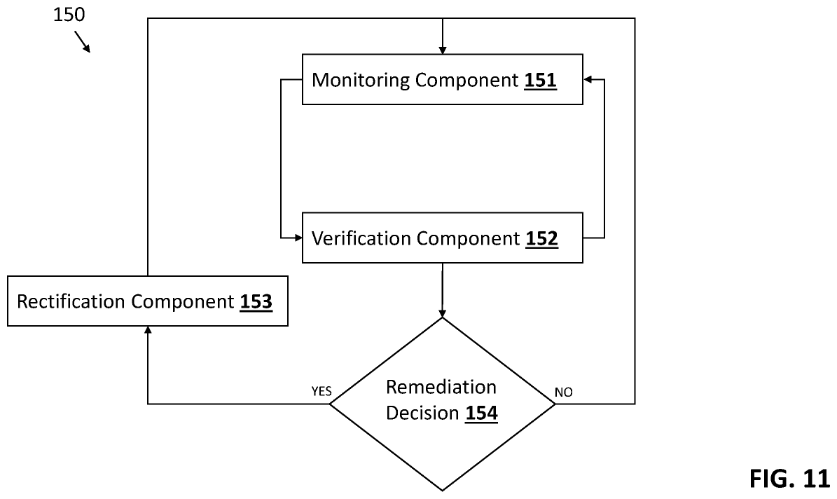

As may be seen with specific reference to FIG. 11, the monitoring component 151 and the verification component 152 may, in certain embodiments, be configured to operate in a loop throughout the cash cycle of the cash in issue. Alternatively put, it may be understood the monitoring component 151 and the verification component 152 may be configured so as to continuously monitor the transportation and auditing of the cash at issue, thereby providing real-time updates as to the status and auditing of same. In so doing, it may be understood the monitoring component 151 and the verification component 152 may therefore be configured to track not only the location of the cash as it is disposed in transit, but to also monitor the auditing status of same, thereby ensuring any inconsistencies regarding the amount of cash-in-transit may be tracked to a given time and/or location. Moreover, in so doing, the final verification of the cash by the verification component 152 upon the deposit of the cash in the cash vault 2330, and the subsequent auditing thereof, may proceed in a quicker and more efficient manner, thereby leading to a faster resolution of any inconsistencies by the rectification component 153. As may be understood, once the rectification component 153 remediates any such inconsistencies, the procedures of the reconciliation component 150 may start once again upon the initial pick-up of the cash from the operator's kiosk(s).

For instance, such embodiments may be configured such that the initial cash pick-up 415 at a given kiosk may be given an initial audit 152a at such time. Such initial audit 152a may then be compared with the transaction data 111 stored in such kiosk application server 100, the first entry 121a and second entry 121b stored in the generated file 121, and the data disposed within the posting file 141 transmitted to the pertinent financial institution. As such, upon such initial audit 151a, the verification component 152 of the present invention may be configured to provide an initial verification 152b of the cash disposed within any given kiosk. As may be understood, such initial verification 152b may then be aggregated with any subsequent verification(s) 152c, thereby providing a continuous verification process configured to identify the locations and/or times of any identified inconsistencies.

Further, in at least one embodiment of the present invention, the verification component 152 may be configured in connection with the cash vault 230 in which the transported cash is ultimately deposited. More specifically, the verification component 152 may be configured such that any cash counting and/or auditing procedures employed therein may be communicated to the verification component 152, thereby allowing same to perform such verification processes, such as those previously discussed. Likewise, the verification component 152 may, at this stage of the cash cycle, may instead perform a comparison analysis between the sum of transaction data 111 ultimately disposed within a posting file 141 upon which a grant of provisional credit is based and the results of such cash counting and/or auditing procedures. As such, the results of the verification component 152 may yield a remediation decision 418, thereby indicating whether the amount of provisional credit issued to the operator was correct or incorrect.

As may be understood, and as may be seen with specific reference to FIG. 11, after the monitoring and verification procedures, the system of at least one embodiment of the present invention may then determine a remediation decision 154. Such remediation decision 154 may be based on the results gathered by the verification component 152. For instance, when the amount of provisional credit issued to the operator was correct, the remediation decision 154 may simply be a decision not to remediate, and, in such instance, such remediation decision 154 may be logged, whether through the kiosk application server 100 or otherwise, and the entire process may start over.

In alternative instances, however, where the remediation decision 154 comprises a decision to remediate, such as those instances wherein the amount of provisional credit is unequal to the amount of cash deposited into the cash vault 230, it may be understood the verification component 152 may then instruct which remedial steps the system should take. Specifically, the verification component 152 may categorize a given kiosk and/or set of kiosks for a particular operator as requiring, without limitation, a reconciliation for an over or under-issuance of provisional credit for a specified amount. As may be understood, the identification of, and issuance of instructions for, alternative remediation situations are envisioned herein. Accordingly, as used herein, the remediation decision 154 applies to all identifications, categorizations, instructions, and/or decisions which may be used to remediate the issues identified by the verification component 152.

As previously discussed, the reconciliation component 150 of at least one embodiment of the present invention may further comprise a rectification component 153. Such rectification component 153 may be disposed on, or in connection with, the kiosk application server 100 and certain other components thereof, such as, for instance, the file generation component 120, the transmission component 130, and the file reformatting component 140. Accordingly, as previously stated, the rectification component 153 may, upon an affirmative remediation decision 154 and the receipt of any instructions and/or data from the verification component 152, such as, for instance, the amount of remediation to be applied for a given posting file 141 transmitted to a given financial institution for a given operator, create, possibly reformat, and ultimately transmit a remedial file 153a to the financial institution. As may be understood, such remedial file 153a may be configured to remediate any discrepancies discerned by the verification component 152.

As may be understood, the remedial file 153a in accordance with at least one embodiment of the present invention may comprise a similar configuration to generated file 121 and/or posting file 141 previously discussed herein. More specifically, the remedial file 153a may comprise two remedial offsetting transactional entries, wherein the first remedial entry 153b posts to the operator's account 210 with the financial institution, and the second remedial entry 153c posts to the financial institution's account with the Federal Reserve 220. As such, the remedial file 153a may be generated, configured, reformatted, and/or transmitted in accordance with those procedures previously discussed herein, whether via the file generation component 120, the transmission component 130, the file reformatting component 140, or through similar components and/or systems disposed within the rectification component 153. As may be understood, such remedial file 153a may therefore by configured to remediate any discrepancies discerned by the verification component 152, thereby ensuring the operator obtains the correct amount of provisional credit while likewise balancing the ledger of the financial institution's account with the Federal Reserve.

In accordance with the foregoing, it may be understood at least one embodiment of the present invention may efficiently and effectively provide provisional credit to kiosk operators without the availability float of prior systems. Specifically, at least one embodiment of the present invention may ensure operators of kiosk are able to obtain provisional credit due to the continuous balancing of the financial institution's balance with the Federal Reserve. Likewise, such a system and method may handle certain logistical problems associated with the execution of transactions at kiosks, while streamlining the cash cycle and allowing for the faster reconciliation thereof. Accordingly, any such system and method may be configured to effectively provide real-time monitoring, updates, and reconciliation to the provisional credit already issued to the operator of the BTM.

Specifically, by continually monitoring the cash, from its initial pick-up at the BTM, throughout its cash-in-transit, and until its eventual deposit and auditing at the cash vault, it May be understood the reconciliation component 150 may provide two things to at least one embodiment of a system of the present invention, namely: (1) the ability to reconcile any inaccuracies present in the system in real-time; and (2) the ability for the operator of the BTM, the financial institution, and/or any applicable third-party to monitor and be aware of any possible reconciliatory actions which may soon follow. As such, the reconciliation component 150 May allow a BTM operator, for instance, to be aware of any possible reconciliatory actions, which May either reduce or enhance the amount of provisional credit provided to the BTM operator, thereby providing the BTM operator with even more information to be used in connection with his or her business. In so doing, it may be understood the BTM operator may then have a greater ability to predict and play the volatile cryptocurrency market, thereby enhancing his or her ability to maximize any potential gains stemming from their kiosk(s).

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A system for obtaining provisional credit to kiosk operators, the system comprising:
at least one kiosk, said at least one kiosk comprising a kiosk application server operatively connected with a core processor of at least one financial institution;
said kiosk application server comprising a transaction component, a file generation component, and a transmission component;
said transaction component configured to execute at least one transaction between the kiosk and a user thereof and to record transaction data associated therewith;
said file generation component configured to generate at least one generated file according to said transaction data, said at least one generated file comprising at least one first entry and at least one second entry; and
said transmission component configured to transmit said at least one generated file to said core processor of said at least one financial institution.

2. The system of claim 1, wherein said at least one first entry is configured to post to the operator's account with said at least one financial institution, and wherein said at least one second entry is configured to post said at least one financial institution's general ledger account.

3. The system of claim 2, wherein said at least one first entry and said at least one second entry are configured to offset each other.

4. The system of claim 1, wherein said kiosk application server further comprises a file reformatting component, said file reformatting component configured to reformat said at least one generated file to at least one posting file.

5. The system of claim 4, wherein said posting file comprises a NACHA file.

6. The system of claim 1, wherein said file generation component is configured to aggregate transaction data from a plurality of kiosks.

7. The system of claim 1, wherein said transmission component comprises a cryptographic network protocol.

8. The system of claim 1, said kiosk application server further comprising a reconciliation component, said reconciliation component comprising:
a monitoring component configured to monitor the cash cycle of the cash that is the subject of said at least one transaction;
a verification component configured to verify whether the amount of said cash is equal to said transaction data; and
a rectification component configured to remediate an imbalance between said cash and said transaction data.

9. The system of claim 8, wherein said remediation of said imbalance between said cash and said transaction data comprises the generation of a remedial file and the subsequent transmission of same to said core processor of said financial institution, said remedial file comprising a first remedial entry and a second remedial entry configured to offset each other.

10. A system for obtaining provisional credit to kiosk operators, the system comprising:
at least one kiosk, said at least one kiosk comprising a kiosk application server operatively connected with a core processor of at least one financial institution;
said kiosk application server comprising a transaction component, a file generation component, a transmission component, and a reconciliation component;
said transaction component configured to execute at least one transaction between the kiosk and a user thereof and to record transaction data associated therewith;
said file generation component configured to generate at least one generated file according to said transaction data, said at least one generated file comprising at least one first entry and at least one second entry;
said at least one first entry configured to post a first amount to the operator's account with said at least one financial institution, and said at least one second entry configured to post a second amount to said at least one financial institution's general ledger account;
said first amount equal to the value recorded in said transaction data;
said second amount equal to an offsetting value from said first amount, such that the posting of said at least one first entry and said at least one second entry does not affect the balance of said at least one financial institution's general ledger account;
said transmission component configured to transmit said at least one generated file to said core processor of said at least one financial institution; and
said reconciliation component configured to remediate said amount of provisional credit issued to the kiosk operator, said reconciliation component comprising:
a monitoring component configured to monitor a cash cycle of the cash that is the subject of said at least one transaction, said cash cycle comprising an initial cash pick-up by a third-party transport and the delivery thereof to a cash vault;
a verification component configured to verify whether the amount of said cash is equal to said transaction data, said verification component configured to continuously aggregate at least one initial verification and at least one subsequent verification to identify a location and time of at least one identified inconsistency; and
a rectification component configured to remediate an imbalance between said cash and said transaction data.

11. The system of claim 10, wherein said kiosk application server further comprises a file reformatting component, said file reformatting component configured to reformat said at least one generated file to at least one posting file.

12. The system of claim 11, wherein said posting file comprises a NACHA file.

13. The system of claim 10, wherein said file generation component is configured to aggregate transaction data from a plurality of kiosks.

14. The system of claim 10, wherein said transmission component comprises a cryptographic network protocol.

15. The system of claim 10, wherein said remediation of said imbalance between said cash and said transaction data comprises the generation of a remedial file and the subsequent transmission of same to said core processor of said financial institution, said remedial file comprising a first remedial entry and a second remedial entry configured to offset each other.

16. A system configured to obtain provisional credit for kiosk operators and reconcile any imbalances therein, said system comprising:
at least one kiosk, said at least one kiosk comprising a kiosk application server operatively connected with a core processor of at least one financial institution;
said kiosk application server comprising a transaction component, a file generation component, a transmission component, and a reconciliation component;
said transaction component configured to execute at least one transaction between the kiosk and a user thereof and to record transaction data associated therewith;
said file generation component configured to generate at least one generated file according to said transaction data, said at least one generated file comprising at least one first entry and at least one second entry;
said at least one first entry configured to post a first amount to the operator's account with said at least one financial institution, and said at least one second entry configured to post a second amount to said at least one financial institution's general ledger account;
said first amount equal to the value recorded in said transaction data;
said second amount equal to an offsetting value from said first amount, such that the posting of said at least one first entry and said at least one second entry does not affect the balance of said at least one financial institution's general ledger account;
said transmission component configured to transmit said at least one generated file to said core processor of said at least one financial institution for the issuance of said amount of provisional credit to the kiosk operator;
said reconciliation component configured to remediate said amount of provisional credit issued to the kiosk operator, said reconciliation component comprising:
a monitoring component configured to monitor the cash which was the subject of said at least one executed transaction while in transit to its deposit in a cash vault;
a verification component configured to issue a remediation decision indicating a difference between said amount of provisional credit issued to the kiosk operator and said cash deposited in said cash vault, said verification component configured to continuously aggregate at least one initial verification and at least one subsequent verification to identify a location and time of at least one identified inconsistency;
said remediation decision comprising an identification of which of said at least one kiosk requires remediation of said amount of provisional credit; and
a rectification component configured to transmit a remedial file to said at least one financial institution, said remedial file comprising a first remedial entry and a second remedial entry configured to offset each other and each comprising an amount equal to said difference between said amount of provisional credit issued to the kiosk operator and said cash deposited in said cash vault.
